(19) United States
(12) Patent Application Publication
(10) Pub. No.: US 2026/0159193 A1
(43) Pub. Date: Jun. 11, 2026

(54) FRONT FORKS FOR BICYCLES

(71) Applicant: SRAM, LLC, CHICAGO, IL (US)

(72) Inventor: MICHAEL MAXWELL, COLORADO SPRINGS, CO (US)

(73) Assignee: SRAM, LLC, CHICAGO, IL (US)

(21) Appl. No.: 19/409,563

(22) Filed: Dec. 4, 2025

Related U.S. Application Data
(60) Provisional application No. 63/729,465, filed on Dec. 8, 2024.

(51) Int. Cl. B62K 25/08

(52) U.S. Cl. CPC B62K 25/08

(57) ABSTRACT

A front fork includes a first upper tube, a second upper tube, a first lower tube, and a second lower tube. The first upper tube and the first lower tube are disposed in a telescopic relationship along a first axis. The second upper tube and the second lower tube are disposed in a telescopic relationship along a second axis. The first lower tube and the second lower tube cooperate to form at least a portion of a lower tube assembly. A bridge is provided between the first lower tube and the second lower tube. At least one relief feature is provided in the bridge.

### CROSS REFERENCE TO RELATED APPLICATIONS

This application claims the benefit of U.S. Provisional Patent Application 63/729,465, filed December 8, 2024, the contents of which are hereby incorporated by reference in its entirety.

### FIELD

The disclosure relates to suspension components for bicycles, and more particularly to front forks for bicycles.

### BACKGROUND

Bicycles may have suspension components. The suspension components advantageously reduce transmission of shocks and/or vibrations to a rider when riding over a bump or obstacle. However, undue friction and wear may result from mismatched dimensions or tolerances during assembly of the suspension components. Conventionally, controlling tolerances of the elements of the suspension components, for example, repeatedly machining the elements of the suspension components, is costly. Accordingly, it is advantageous to provide a suspension arrangement that facilitates easy and reliable assembly of suspension components that alleviate problems of mismatched dimensions or tolerances.

### SUMMARY

Therefore, an object of the disclosure is to provide front forks that can alleviate bushing mismatch or strain.

According to the disclosure, a front fork for a bicycle includes at least one bushing. The bushing is disposed about an axis, and has an inner surrounding surface, and an outer surrounding surface that is opposite to the inner surrounding surface. The inner surrounding surface of the bushing interfaces with a first tube and the outer surrounding surface interfaces with a second tube. The first tube and the second tube are in telescopic arrangement along a travel axis.

### BRIEF DESCRIPTION OF THE DRAWINGS

Other features and advantages of the disclosure will become apparent in the following detailed description with reference to the accompanying drawings. It is noted that various features may not be drawn to scale.

FIG. 1 is a side view of an example of a bicycle.

FIG. 2 is a front view of an example front fork that may be employed with the example bicycle of FIG. 1.

FIG. 3 is a partial side view of the front fork of FIG. 2.

FIG. 4 is an enlarged view of the side view of FIG. 3.

FIG. 5 is a partial sectional view of the front fork of FIG. 2 taken along line A-A in FIG. 2.

FIG. 6 is an enlarged view of the partial sectional view of FIG. 5.

FIG. 7 is a partial side view of another example fork that may be employed with a bicycle as in FIG. 1.

FIG. 8 is a sectional view of the partial side view of FIG. 7, in a similar view to that along line A-A in FIG. 1.

FIG. 9 is a partial front view of another example fork that may be employed with the bicycle as in FIG. 1.

FIG. 10 is a partial side view of the example fork of FIG. 9.

FIG. 11 is a partial sectional view of the example fork of FIG. 9 taken along line B-B in FIG. 9.

The figures may not be to scale. Instead, the thickness of the layers or regions may be enlarged in the drawings. In general, the same reference numbers will be used throughout the drawing(s) and accompanying written description to refer to the same or like parts.

Other aspects and advantages of the embodiments disclosed herein will become apparent upon consideration of the following detailed description, wherein similar or identical structures may have similar or identical reference numerals.

### DETAILED DESCRIPTION

Reference will now be made in detail to various examples which are illustrated in the accompanying drawings. The detailed description uses numerical and letter designations to refer to features in the drawings. Like or similar designations in the drawings and description have been used to refer to like or similar parts.

The word “exemplary” is used herein to mean “serving as an example, instance, or illustration.” Any implementation described herein as “exemplary” is not necessarily to be construed as preferred or advantageous over other implementations.

The descriptors used herein, including the terms “first”, “second”, “third”, etc. may be used interchangeably to distinguish one component from another and are not intended to signify location or importance of the individual components. Unless otherwise specified or understood based on their context of use, such descriptors are not intended to impute any meaning of priority or ordering in time but merely as labels for referring to multiple elements or components separately for ease of understanding the disclosed examples. In some examples, the descriptor "first" may be used to refer to an element in the detailed description, while the same element may be referred to in a claim with a different descriptor such as "second" or "third." In such instances, it should be understood that such descriptors are used merely for ease of referencing multiple elements or components.

The terms “coupled,” “fixed,” “attached to,” and the like refer to both direct coupling, fixing or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Various suspension components may be provided with reference to the following disclosure. For example, front suspension forks, rear suspension shocks, seatposts, and various other suspension components are contemplated in connection with the features that follow. Proceeding with the example of front suspension on a bicycle, a front fork typically includes a crown, a steerer tube extending upward from the crown, and two legs extending downward from the crown. Each leg has an upper tube that is connected to the crown and a lower tube that is to be connected to the front wheel. The upper and lower tubes are arranged in a telescopic relationship. In some instances, a damper is disposed in one of the legs and a spring (e.g., an air spring, a coil spring) is disposed in the other leg. The spring enables the front fork to compress or contract when riding over a bump or obstacle, thereby reducing the transmission of shocks and vibrations to the rider, and then returns the fork to an expanded state after the compressive force is removed.

A conventional bicycle suspension component may include a first tube, a second tube having an insertion portion that is movable along an axis within the first tube, and a plurality of bushings disposed between the first tube and the insertion portion of the second tube. Specifically, each of the bushings has an inner cylindrical surface that is in slidable contact with an outer surface of the insertion portion of the second tube, and an outer cylindrical surface that is opposite to the inner cylindrical surface and that is coupled to an inner surface of the first tube. The fit between the inner surface of the first tube and the outer cylindrical surface of each of the bushings is a press fit (also referred to as an interference fit). As each of the bushings is press fit into the first tube, deformation may occur. For example, since the configuration of the outer cylindrical surface leads to low flexibility in a radial direction, each of the bushings may deform such that the inner cylindrical surface thereof is significantly twisted or bent. As such, the inner cylindrical surface of each of the bushings may not be aligned with the outer surface of the insertion portion of the second tube along the axis, and an effective inner diameter of each of the bushings may be reduced. As a result, each of the bushings may not be able to facilitate smooth relative movement between the first tube and the second tube, and may need to undergo additional processes, for example a reaming process.

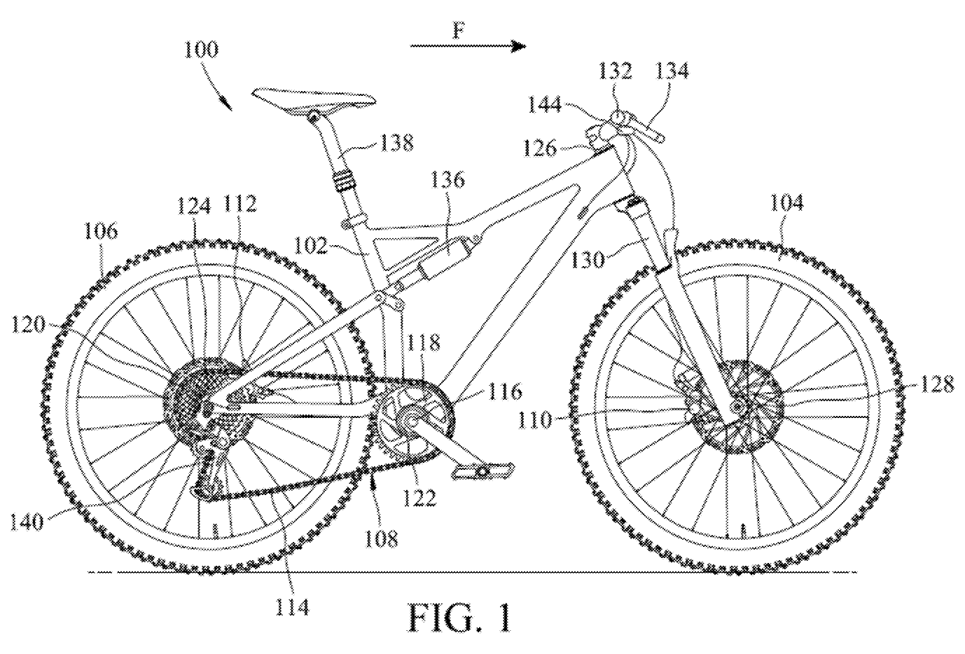

FIG. 1 illustrates an example bicycle 100 that includes a main frame 102, a front wheel 104, a rear wheel 106, and a drivetrain 108. The front wheel 104 and the rear wheel 106 are rotatably connected to the main frame 102. In the illustrated example, the bicycle 100 further includes a braking system that includes a front brake 110 and a rear brake 112 for respectively braking the front wheel 104 and the rear wheel 106. In the illustrated example, the drivetrain 108 includes a chain 114, a crank assembly 116 rotatably mounted to the main frame 102, a front sprocket assembly 118 coaxially mounted to the crank assembly 116, and a rear sprocket assembly 120 coaxially mounted to the rear wheel 106. Each of the front sprocket assembly 118 and the rear sprocket assembly 120 includes at least one sprocket. The direction of arrow (F) in FIG. 1 indicates a forward direction of movement for the bicycle 100.

In the illustrated example, the bicycle 100 includes a bottom bracket 122, a rear wheel hub 124, a headset 126, and a front wheel hub 128. The bottom bracket 122 is mounted to a bottom portion of the main frame 102, and supports the crank assembly 116 relative to the main frame 102. The rear wheel hub 124 is mounted to a rear portion of the main frame 102, and supports the rear wheel 106 and the rear sprocket assembly 120 relative to the main frame 102. The headset 126 is mounted to a front portion of the main frame 102. In the illustrated example, the front wheel 104 is coupled to the front portion of the main frame 102 via a front fork 130 that is rotatably mounted to the headset 126. The front wheel hub 128 is mounted to a bottom portion of the front fork 130, and supports the front wheel 104 relative to the front fork 130. The bicycle 100 may further have a handlebar 132 that is connected to and rotatable with the front fork 130. In some examples, the front fork 130 may be configured as a suspension fork. In some examples, the bicycle 100 may have a rear shock absorber 136 for damping rear shock and/or a dropper seat post 138.

In the illustrated example of FIG. 1, the bicycle 100 may have a single-speed drivetrain or a multi-speed drivetrain which has a shifting system. For example, the bicycle 100 may have a multiple-geared drivetrain 108 that may have one or both of a front gear changer (described further below as a front shifting system) and a rear gear changer mounted to the main frame 102. The gear changers may be mechanical or electromechanical derailleurs, internal gear systems, for example front gearboxes and/or rear internal gear hubs including planetary gearing. The illustrated example includes a rear derailleur 140 without a front shifting system, but it should be appreciated that any combination of gear changers is contemplated. The gear changers can be operated using one or more gear shifters 144, which may be mounted to the handlebar 132. The gear shifters 144 may operate the gear changers through wired or wireless signal communication, or via a physical connection using a mechanical shift cable or hydraulic line. The bicycle 100 as described above and shown in FIG. 1 is a full-suspension mountain bike with a flat handlebar. Those having ordinary skill in the art should recognize that the type and style of bicycle may vary from the disclosed example. For example, a road bicycle with drop-style handlebars, along with a drivetrain having road type gearing with a road gear range may be used instead of a mountain bike or other bicycle gear range, or an e-bike with an integrated electric motor used to assist propulsion.

In this example, the bicycle 100 includes brake system. The brake system includes at least one brake lever 134 that is movably connected to the handlebar 132. The brake lever 134 is configured to operate components of the brake system of the bicycle 100. In one example, the brake system can include one or both of a hydraulic or cable actuated front brake mechanism coupled to the front wheel 104 via a hydraulic line or mechanical cable and a hydraulic or cable actuated rear brake mechanism coupled to the rear wheel 106 through a hydraulic line or mechanical cable. As noted above, the brake system can be a hydraulically actuated system or a mechanically actuated system.

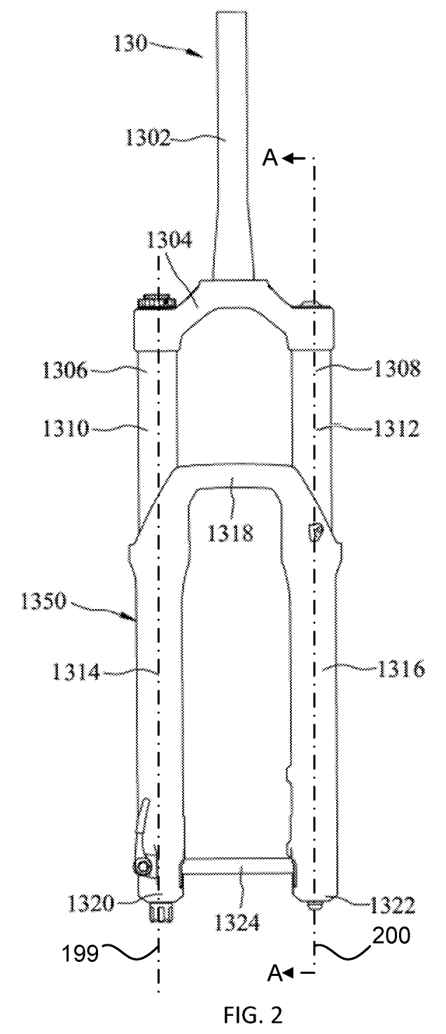

FIG. 2 is a front view of an example suspension front fork. In the illustrated example, the front fork 130 includes a steerer tube 1302, a crown 1304, a first leg 1306, and a second leg 1308. The steerer tube 1302 is coupled to and extends upward from the crown 1304. The first and second legs 1306, 1308 are coupled to and extend downward from the crown 1304. The steerer tube 1302 is coupled to and rotatable with the crown 1304. For example, the steerer tube 1302 may be pressed, keyed, bonded, or otherwise attached with the crown 1304. In an embodiment, the steerer tube 1302 is formed with the crown 1304, for example as a unitary component.

In the illustrated example in FIG. 2, each of the first and second legs 1306, 1308 include an upper tube 1310, 1312 and a lower tube 1314, 1316. The upper tubes 1310, 1312 of the first and second legs 1306, 1308 may cooperatively form an upper tube assembly. The lower tubes 1314, 1316 of the first and second legs 1306, 1308 may cooperatively form a lower tube assembly 1350. The upper tubes 1310, 1312 of the first and second legs 1306, 1308 are coupled to and extend from the crown 1304. In some examples, the lower tubes 1314, 1316 of the first and second legs 1306, 1308 may be coupled together via a brace. For example, as shown in FIG. 2, a brace is provided in the form of a bridge 1318. As shown, the bridge 1318 may be formed as a unitary element with the lower tubes 1314, 1316, but it should be appreciated that the bridge 1318 may be separately provided, for example as an element removable from the lower tubes 1314, 1316. In some examples, the lower tubes 1314, 1316 of each of the first and second legs 1306, 1308 may include a front wheel attachment portion 1320, 1322 through which an axle 1324 extends for mounting the front wheel 104 (see FIG. 1).

In various examples, the upper tubes 1310, 1312 and the lower tubes 1314, 1316 may define telescopic relationships. For example, the upper tubes 1310, 1312 may be telescopically received within the lower tubes 1314, 1316. In another example, referred to as an upside-down configuration, the lower tubes 1314, 1316 may be telescopically received within the upper tubes 1310, 1312. The telescopic relationship between the first upper tube 1310 and the first lower tube 1314 may be described along a first leg axis 199. The telescopic relationship between the second upper tube 1312 and the second lower tube 1316 may be described along a second leg axis 1316.

In the example of FIG. 2, the upper tubes 1310, 1312 of the first and second legs 1306, 1308 are respectively slidably received within the lower tubes 1314, 1316 of the first and second legs 1306, 1308. Specifically, each of the lower tubes 1314, 1316 of the first and second legs 1306, 1308 has an interior wall that defines an interior volume therein. Each of the upper tubes 1310, 1312 of the first and second legs 1306, 1308 is movable at least in part within the interior volume of the respective one of the lower tubes 1314, 1316. Thus, each of the upper tubes 1310, 1312 forms a telescopic arrangement with the respective one of the lower tubes 1314, 1316. During a compression stroke, the upper tubes 1310, 1312 respectively move into or toward the lower tubes 1314, 1316. During a rebound stroke, the upper tubes 1310, 1312 respectively move out of or away from the lower tubes 1314, 1316.

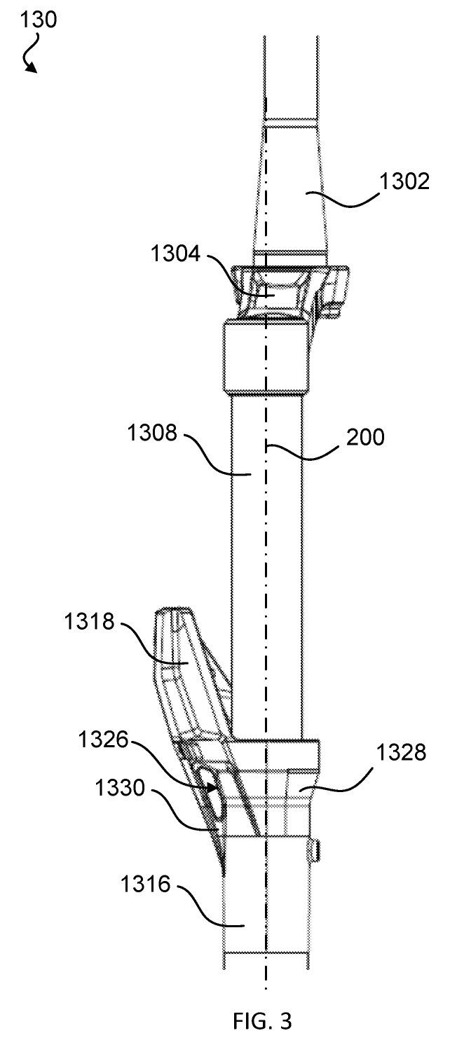

FIG. 3 is a side view of the front fork 130 of FIG. 2. As shown in FIG. 3, at least one relief feature 1326 may be provided with the front fork 130. For example, a relief feature 1326 may be associated with each of the lower tubes 1314, 1316 of the lower tube assembly 1350. The relief feature 1326 is provided to relieve forces between the lower tubes 1314, 1316 and the bridge 1318. For example, the relief feature 1326 may be shaped and sized to evenly distribute forces around a bushing region 1328 of the front fork 130. As used herein, the bushing region generally refers to a region where at least one bushing, for example an upper bushing, is housed. Forces around the bushing region 1328 may be controlled with the relief feature 1326 to ensure even loading of the bushing region 1328 during riding.

The relief feature 1326 may generally be formed as an opening. As shown in FIG. 3, the opening of the relief feature 1326 may generally be aligned orthogonal to the axis 200. Alternatively, the relief feature 1326 may be aligned parallel with the axis 200, for example plunging through material of the brace or bridge 1318 parallel to the second leg axis 200. It should also be appreciated that the relief feature 1326 may be otherwise arranged in any other angular relationship to achieved desired operation and stress management.

Still referring to FIG. 3, a standoff 1330 may be provided between the second lower tube 1316 and the bridge 1318. The standoff 1330 may cooperate with and at least in part define the relief feature 1326. In an example, the standoff 1330 is provided to transmit force from the bridge 1318 to a region outside of, for example above or below relative to the second leg axis 200, the bushing region 1328.

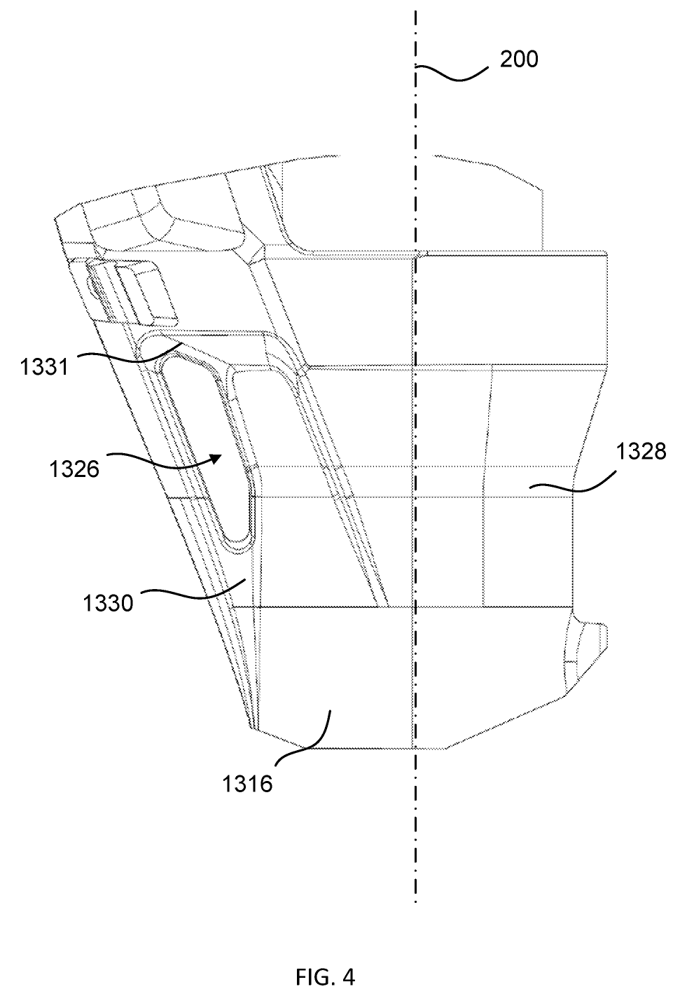

Turning now to FIG. 4, an enlarged view of the front fork 130 of FIG. 3 is shown. As depicted in FIG. 4, a second standoff 1331 may be provided such that the relief feature 1326 is defined between the standoffs 1330, 1331 along the second leg axis 200. The extent of the relief feature 1326 along the second leg axis 200 may generally correspond with an extent of the bushing region 1328 along the second leg axis 200. For example, a majority of the bushing region 1328 may overlap with the relief feature 1326 along the second leg axis 200.

As shown in FIG. 4, the relief feature 1326 may generally be defined as parallel with a plane defined to include the first leg axis 199 and the second leg axis 200. For example, the relief feature 1326 may generally align with the extent of the bridge 1318. However, it should be appreciated that the relief feature 1326 may be variously aligned with the front fork 130 and still operate to control forces in the bushing region 1328.

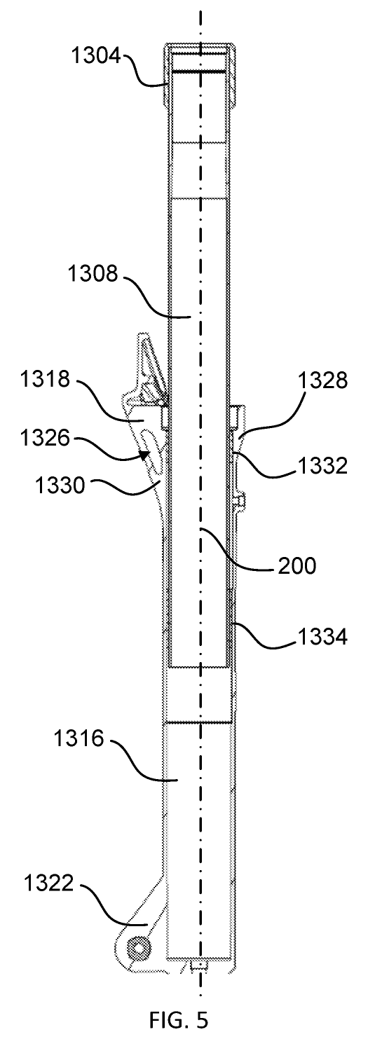

Turning now to FIG. 5, a sectional view of the front fork 130 is shown taken along line A-A in FIG. 2. FIG. 5 shows an upper bushing 1332 and a lower bushing 1334 disposed between the second upper tube 1308 and the second lower tube 1316. A bushing region may be defined between the upper bushing 1332 and the lower bushing 1334. In various examples, the upper bushing 1332 may generally defined the bushing region 1328 as described above. For example, the bushing region 1328 may be defined as an extent of the upper bushing 1332 along the second leg axis 200. However, it should be appreciated that the bushing region 1328 may be defined differently, for example as a region of direct force transmission to the upper bushing 1332.

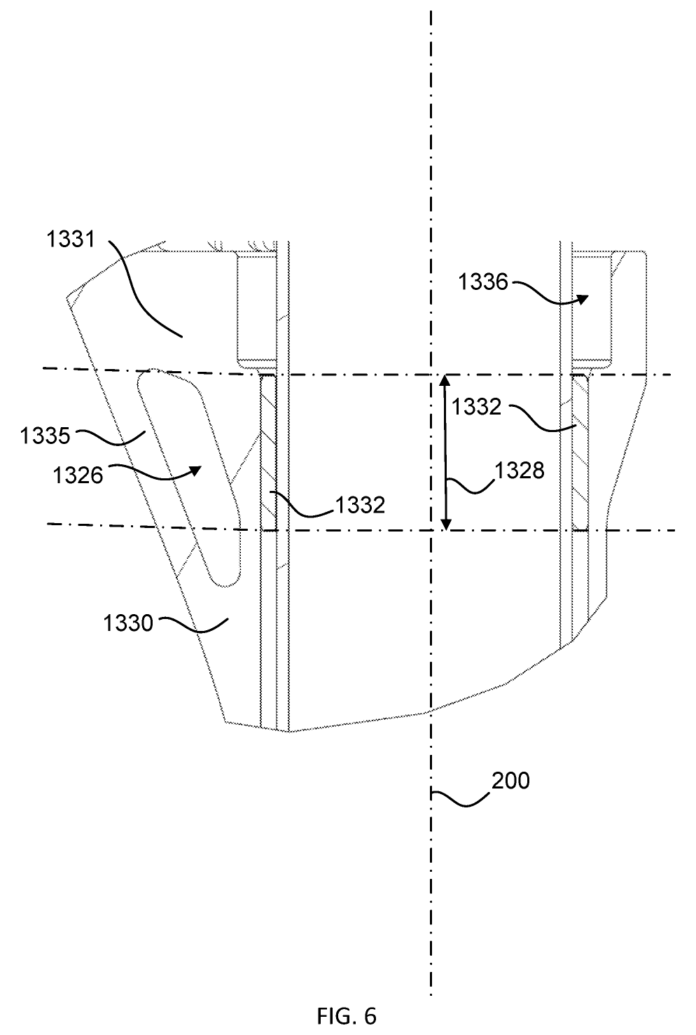

Referring now to FIG. 6, an enlarged view of the sectional view of FIG. 5 is provided. As shown in FIG. 6, the extent of the bushing region 1328 may be defined directly with the length of the upper bushing 1332 along the second leg axis 200. Although these features are described with reference to the second leg axis 200, it should be appreciated that these features may similarly be associated with the first leg axis 199 and associated elements.

A relief connector 1335 may also be provided. For example, as shown in FIG. 6, the relief connector 1335 may connect the first standoff 1330 with the second standoff 1331. Accordingly, the relief connector 1335 may transmit force between the standoffs 1330, 1331 and around the relief feature 1326. The relief connector 1335 and the standoffs 1330, 1331 may cooperate to at least in part define the extent of the relief feature 1326. As can be seen in FIG. 6, the extent of the upper bushing 1332 along the second leg axis 200 is entirely overlapping with the extent of the relief feature 1326 defined in this manner.

FIG. 6 further depicts a seal region 1336. The seal region 1336 may generally be shaped and sized to retain at least one seal element (not shown). For example, a lubrication element such as an oiled foam ring and a lip seal may at least in part define the at least one seal element (not shown). The relief feature 1326 may also be configured to distribute forces around the seal region 1336. Additionally, or alternatively, the seal region 1336 may be configured as a preferred load path around the bushing region 1328. For example, the second standoff 1331 may be arranged to preferentially load the seal region 1336 while leaving the bushing region 1328 relatively unloaded.

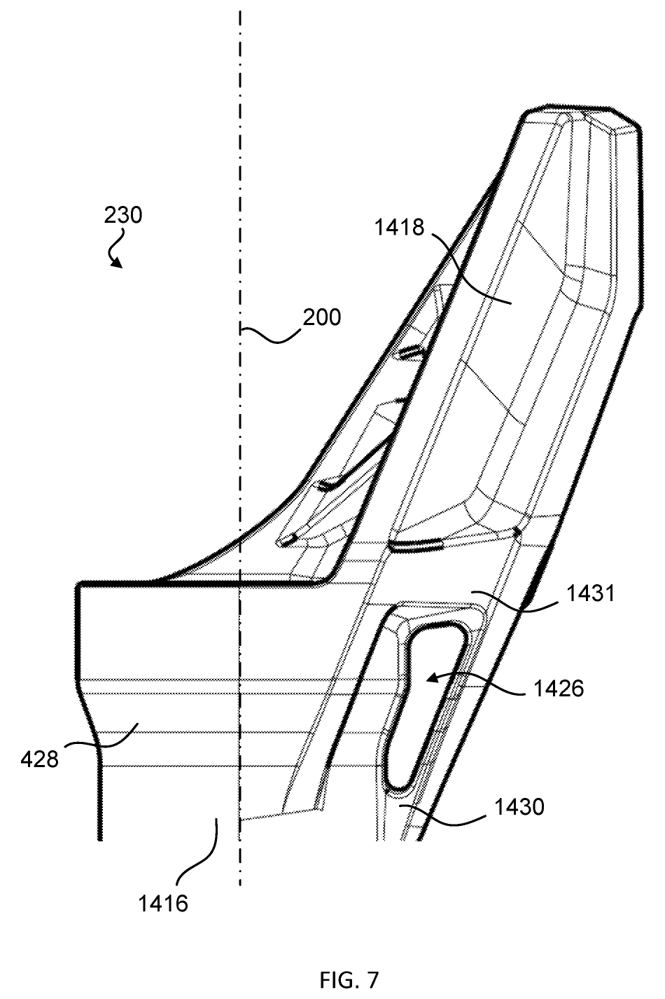

Turning now to FIG. 7, another example of a front fork 230 is shown. The embodiment of FIG. 7 shows a relief feature 1426 disposed between a first standoff 1430 and a second standoff 1431 in a bushing region 1428 of a second lower tube 1416. The relief feature 1426 as described elsewhere herein may generally control forces from a bridge 1418 adjacent the bushing region 1428.

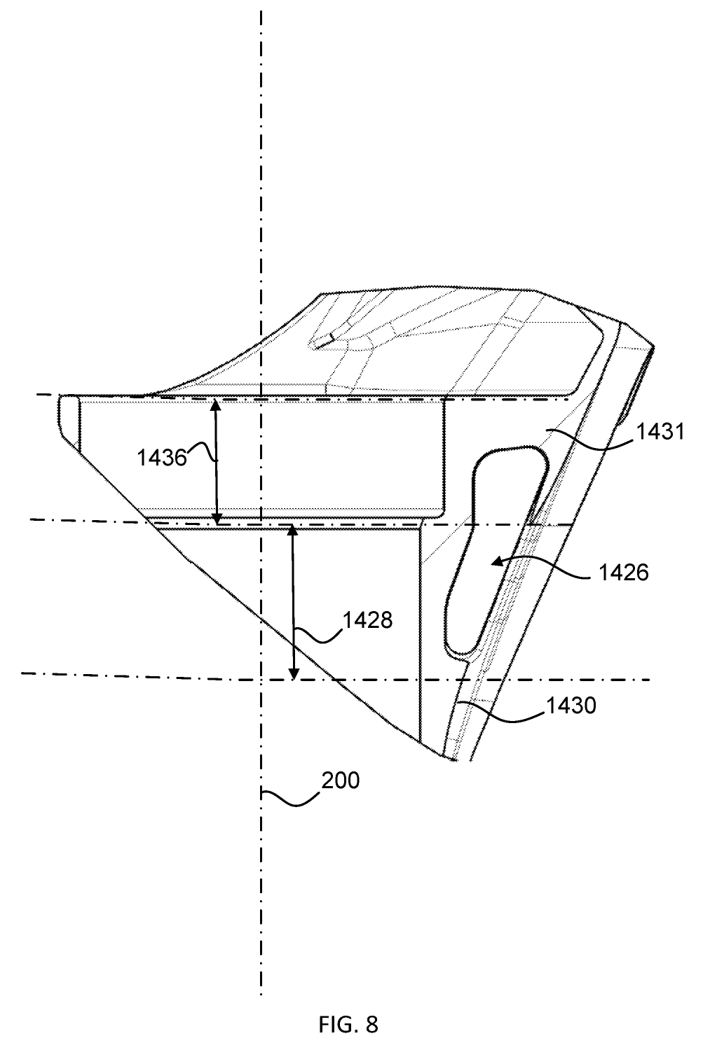

Referring to FIG. 8, an enlarged sectional view corresponding to the view of FIG. 7, the bushing region 1428 may extend beyond, for example below, the extent of the relief feature 1426 along the second leg axis 200. Additionally or alternatively, the relief feature 1426 may extend into a seal region 1436 along the second leg axis 200.

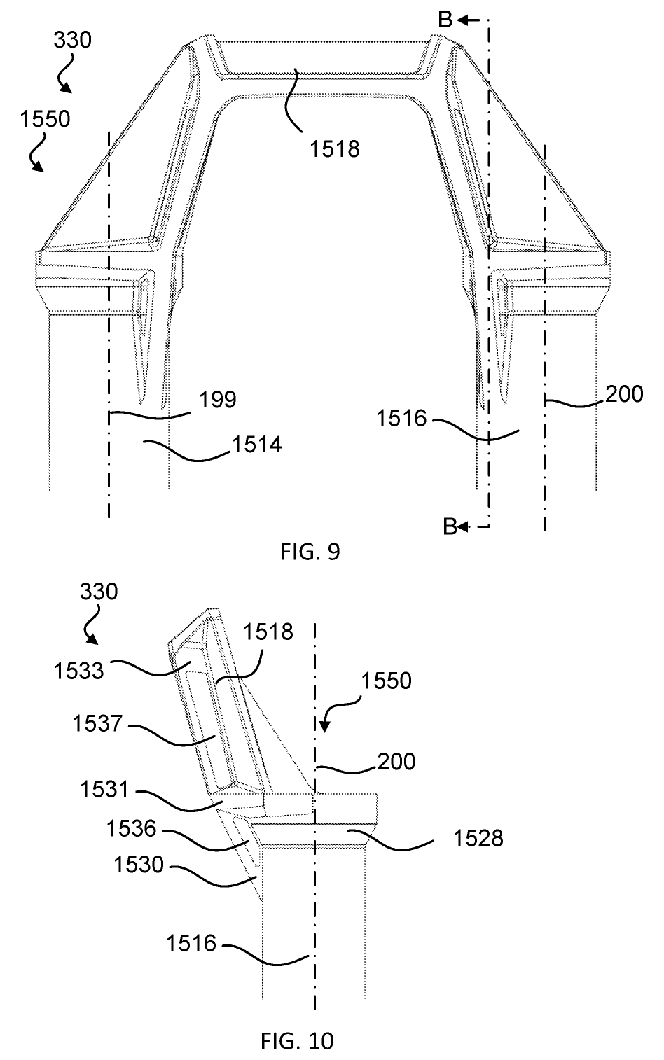

Turning now to FIG. 9, another embodiment of an example front fork 330 is provided. The front fork 330 is shown in partial view as a lower tube assembly 1550. The lower tube assembly 1550 of FIG. 9 includes a first lower tube 1514, a second lower tube 1516, and a bridge 1518 between the first lower tube 1514 and the second lower tube 1516.

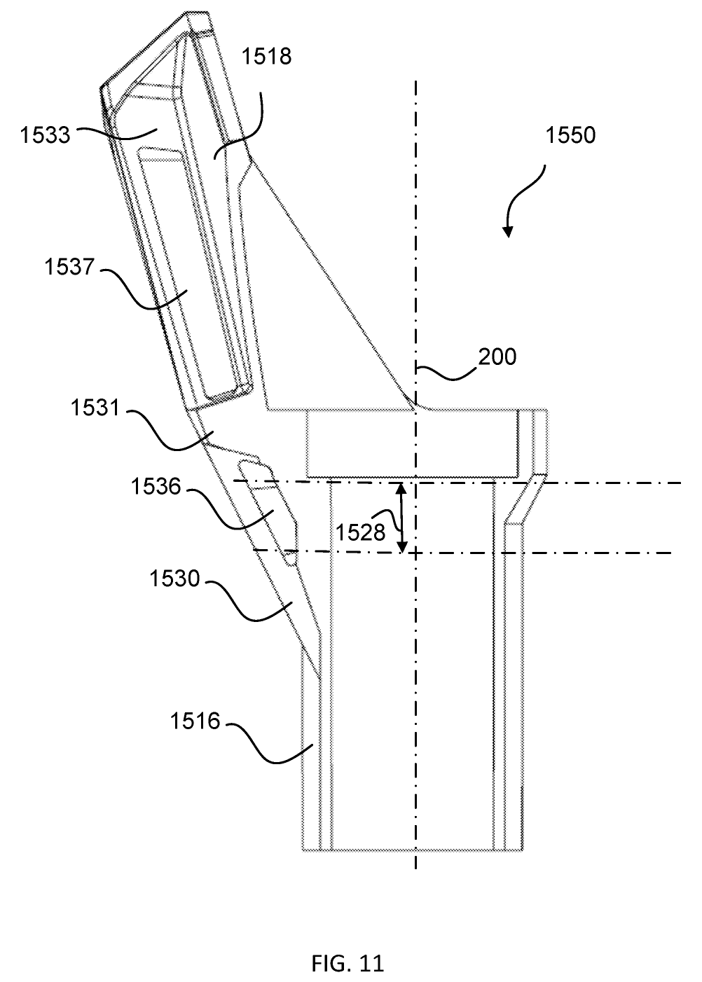

Turning to FIG. 10, a side view of the lower tube assembly 1550 of FIG. 9 is provided. FIG. 11 provides a corresponding sectional view taken along line B-B in FIG. 9. As can be seen in FIGS. 10 and 11, a first relief feature 1536 and a second relief feature 1537 are shown. A first standoff 1530 is provided below the first relief feature 1536. A second standoff 1531 is provided between the first relief feature 1536 and the second relief feature 1537. A third standoff 1533 is provided above the second relief feature 1537. The first relief feature 1536 and the second relief feature 1537 may cooperate to distribute loads around a bushing region 1528. The standoffs 1530, 1531, 1533 may cooperate to isolate the bushing region 1528 and/or the second lower tube 1516 from the bridge 1518. In an example, the bushing region 1528 may entirely overlap the first relief feature 1526 along the second leg axis 200.

The embodiments described herein may be provided with any of the features and elements as shown and described. The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the disclosure or of what may be claimed, but rather as descriptions of features specific to particular embodiments of the disclosure. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed. Further examples are provided in the clauses below:

A telescopic bicycle component comprising: a first tube; a second tube in a telescopic relationship with the first tube along an axis; a bushing disposed in a bushing region and at least in part controlling the telescopic relationship between the first tube and the second tube; a brace disposed in a brace connection region, the brace supporting the second tube relative to at least one further element; and a relief feature disposed in the bushing region between the brace and the second tube, the relief feature to control a stiffness in the bushing region.

The telescopic bicycle component of the preceding clause, wherein the relief feature defines an opening to reduce the stiffness in the bushing region.

The telescopic bicycle component of any one of the preceding clauses, wherein the relief feature comprises a first standoff and a second standoff defining opposite ends of the opening.

The telescopic bicycle component of any one of the preceding clauses, wherein the first standoff is disposed above the opening and the second standoff is disposed below the opening along the axis.

The telescopic bicycle component of any one of the preceding clauses, wherein the bushing region and the brace connection region overlap along the axis.

The telescopic bicycle component of any one of the preceding clauses, wherein the first tube and the second tube form part of a first fork leg and the at least one further element is a second fork leg.

The telescopic bicycle component of any one of the preceding clauses, wherein the brace is a bridge connecting the second tube with a lower tube of the second fork leg.

The telescopic bicycle component of any one of the preceding clauses, wherein the relief feature aligns with an extent of the bridge between the first fork leg and the second fork leg.

The telescopic bicycle component of any one of the preceding clauses, wherein an axial extent of the relief feature is greater than an axial extent of the bushing.

A front fork assembly for a bicycle, the front fork assembly comprising: a first upper tube; a second upper tube; and a lower tube assembly comprising: a first lower tube in a telescopic relationship with the first upper tube along a first axis and controlled by a first bushing; a second lower tube in a telescopic relationship with the second upper tube along a second axis and controlled by a second bushing; and a bridge connecting the first lower tube and the second lower tube, the bridge comprising a first relief feature overlapping the first bushing along the first axis and a second relief feature overlapping the second bushing along the second axis.

The front fork assembly of any one of the preceding clauses, further comprising a first standoff and a second standoff disposed on opposite sides of the first relief feature along the first axis; and a third standoff and a fourth standoff disposed on opposite sides of the second relief feature along the second axis.

The front fork assembly of any one of the preceding clauses, wherein the first relief feature and the second relief feature are aligned as parallel with a plane defined to include the first axis and the second axis.

The front fork assembly of any one of the preceding clauses, wherein the first relief feature and the second relief feature are aligned as orthogonal to a direction of travel.

The front fork assembly of any one of the preceding clauses, wherein the first relief feature and the second feature are aligned with an extent of the bridge between the first axis and the second axis.

The front fork assembly of any one of the preceding clauses, further comprising a third relief feature disposed above the first relief feature along the first axis and a fourth relief feature disposed above the second relief feature along the second axis.

The front fork assembly of any one of the preceding clauses, wherein the first relief feature entirely overlaps the first bushing along the first axis and wherein the second relief feature entirely overlaps the second bushing along the second axis.

A front fork assembly for a bicycle, the front fork assembly comprising: a first upper tube; a second upper tube; and a lower tube assembly comprising: a first lower tube in a telescopic relationship with the first upper tube along a first axis and controlled by a first bushing; a second lower tube in a telescopic relationship with the second upper tube along a second axis and controlled by a second bushing; a bridge connecting the first lower tube and the second lower tube; a first standoff isolating the bridge from the first lower tube; and a second standoff isolating the bridge from the second lower tube.

The front fork assembly of any one of the preceding clauses, wherein the first standoff is spaced apart from a third standoff along the first axis and the second standoff is spaced apart from a fourth standoff feature along the second axis.

The front fork assembly of any one of the preceding clauses, wherein the first standoff and the third standoff define opposite ends of a first opening of a first relief feature and wherein the second standoff and the fourth standoff define opposite ends of second opening of a second relief feature.

The front fork assembly of any one of the preceding clauses, wherein a first distance between the first standoff and the third standoff is greater than a length of the first bushing along the first axis and wherein a second distance between the second standoff the fourth standoff is greater than a length of the second bushing along the second axis.

What is claimed is:

1. A telescopic bicycle component comprising:
a first tube;
a second tube in a telescopic relationship with the first tube along an axis;
a bushing disposed in a bushing region and at least in part controlling the telescopic relationship between the first tube and the second tube;
a brace disposed in a brace connection region, the brace supporting the second tube relative to at least one further element; and
a relief feature disposed in the bushing region between the brace and the second tube, the relief feature to control a stiffness in the bushing region.

2. The telescopic bicycle component of claim 1, wherein the relief feature defines an opening to reduce the stiffness in the bushing region.

3. The telescopic bicycle component of claim 2, wherein the relief feature comprises a first standoff and a second standoff defining opposite ends of the opening.

4. The telescopic bicycle component of claim 3, wherein the first standoff is disposed above the opening and the second standoff is disposed below the opening along the axis.

5. The telescopic bicycle component of claim 1, wherein the bushing region and the brace connection region overlap along the axis.

6. The telescopic bicycle component of claim 1, wherein the first tube and the second tube form part of a first fork leg and the at least one further element is a second fork leg.

7. The telescopic bicycle component of claim 6, wherein the brace is a bridge connecting the second tube with a lower tube of the second fork leg.

8. The telescopic bicycle component of claim 7, wherein the relief feature aligns with an extent of the bridge between the first fork leg and the second fork leg.

9. The telescopic bicycle component of claim 1, wherein an axial extent of the relief feature is greater than an axial extent of the bushing.

10. A front fork assembly for a bicycle, the front fork assembly comprising:
a first upper tube;
a second upper tube; and
a lower tube assembly comprising:
a first lower tube in a telescopic relationship with the first upper tube along a first axis and controlled by a first bushing;
a second lower tube in a telescopic relationship with the second upper tube along a second axis and controlled by a second bushing; and
a bridge connecting the first lower tube and the second lower tube, the bridge comprising a first relief feature overlapping the first bushing along the first axis and a second relief feature overlapping the second bushing along the second axis.

11. The front fork assembly of claim 10, further comprising a first standoff and a second standoff disposed on opposite sides of the first relief feature along the first axis; and a third standoff and a fourth standoff disposed on opposite sides of the second relief feature along the second axis.

12. The front fork assembly of claim 10, wherein the first relief feature and the second relief feature are aligned as parallel with a plane defined to include the first axis and the second axis.

13. The front fork assembly of claim 10, wherein the first relief feature and the second relief feature are aligned as orthogonal to a direction of travel.

14. The front fork assembly of claim 10, wherein the first relief feature and the second feature are aligned with an extent of the bridge between the first axis and the second axis.

15. The front fork assembly of claim 10, further comprising a third relief feature disposed above the first relief feature along the first axis and a fourth relief feature disposed above the second relief feature along the second axis.

16. The front fork assembly of claim 10, wherein the first relief feature entirely overlaps the first bushing along the first axis and wherein the second relief feature entirely overlaps the second bushing along the second axis.

17. A front fork assembly for a bicycle, the front fork assembly comprising:
a first upper tube;
a second upper tube; and
a lower tube assembly comprising:
a first lower tube in a telescopic relationship with the first upper tube along a first axis and controlled by a first bushing;
a second lower tube in a telescopic relationship with the second upper tube along a second axis and controlled by a second bushing;
a bridge connecting the first lower tube and the second lower tube;
a first standoff isolating the bridge from the first lower tube; and
a second standoff isolating the bridge from the second lower tube.

18. The front fork assembly of claim 17, wherein the first standoff is spaced apart from a third standoff along the first axis and the second standoff is spaced apart from a fourth standoff feature along the second axis.

19. The front fork assembly of claim 18, wherein the first standoff and the third standoff define opposite ends of a first opening of a first relief feature and wherein the second standoff and the fourth standoff define opposite ends of second opening of a second relief feature.

20. The front fork assembly of claim 18, wherein a first distance between the first standoff and the third standoff is greater than a length of the first bushing along the first axis and wherein a second distance between the second standoff the fourth standoff is greater than a length of the second bushing along the second axis.
